(19) United States
(12) Patent Application Publication
(10) Pub. No.: US 2005/0204311 A1
(43) Pub. Date: Sep. 15, 2005

(54) Photographing apparatus for displaying OSD menu and method thereof

(75) Inventor: Kuie-sup Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/050,709

(22) Filed: Feb. 7, 2005

(30) Foreign Application Priority Data
Mar. 10, 2004 (KR) 10-2004-0016089

(51) Int. Cl. G06F 3/00

(52) U.S. Cl. 715/823; 715/767; 715/860; 715/810; 715/822

(57) ABSTRACT

A photographing apparatus in which a menu is displayed in an on screen display (OSD), the apparatus having an OSD generating part for generating a plurality of OSD menu items in different colors, a displaying part for displaying a list of menu items on a screen, and a controlling part for controlling the OSD generating part and the displaying part so as to display a list of submenu items of a selected OSD menu item in the same color as the selected menu item when one of the OSD menu items is selected. Thus, the selected menu item and the submenu are displayed in the same color, thereby increasing the discrimination between each.

### CROSS-REFERENCE TO RELATED APPLICATIONS

This application claims the benefit under 35 U.S.C. §119(a) of Korean Patent Application No. 10-2004-0016089 filed in the Korean Intellectual Property Office Mar. 10, 2004, the entire contents of which are incorporated herein by reference.

### BACKGROUND OF THE INVENTION

1. Field of the Invention

The present invention relates to a photographing apparatus. More particularly, the present invention relates to a photographing apparatus for displaying an OSD (On Screen Display) menu and an implementation method thereof, in which a size of a menu item selected from OSD type menu items is changed, and a submenu of the selected menu is also displayed in the same color, thereby improving discrimination between the menu items.

2. Description of the Related Art

With the development of electronics technology, miniaturized and light-weight electronic appliances have been developed and popularized in various fields. Digital cameras and digital camcorders are examples of such electronic appliances. These digital photographing apparatus have a greater variety of functions than existing optical photographing apparatus. Further, since the digital photographing apparatus is provided with an LCD display window, an image which has been taken, or which is being taken, can be easily confirmed. Therefore, the use thereof is more widespread.

In using these digital photographing apparatus, a user can actively use the functions provided in the digital photographing apparatus according to his or her taste by using a menu function. For example, the user can freely set functions such as a color mode, a black and white mode, a resolution of image, a luminance of image, a shutter speed, and also change an operational environment of the photographing apparatus which is preset.

The menu function is typically displayed in an OSD type. The user can change the preset function of the photographing apparatus by selecting the OSD type menu using a direction button and a numeral button.

FIGS. 1A and 1B are views showing a display state of a conventional OSD menu in a photographing apparatus. Referring to FIG. 1A, a main menu 11 is vertically aligned on a left side of a screen 10. A cursor 15 is positioned at any one of the menu items, for example, item “3. Set-Up” menu item as shown in FIG. 1A. On a right side of the screen 10, a submenu 13 of the “3. Set-Up” menu item on which the cursor 15 is positioned, is also vertically aligned.

The user can change the function by selecting the menu item using the appropriate buttons, such as direction button or the numeral button. That is, the user can move the cursor 15 by operating the direction button up and down on the main menu 11 items displayed on the screen 10, and thus change the main menu item. The submenu 13 of the main menu item is then displayed on the right side of the screen 10. The user can also input a right direction button, so that the cursor 15 is moved to the submenu 13 from the main menu 11. After the setting operation, the user can input a left direction button again, so that the cursor 15 is returned to the main menu 11. If the user presses a setting button while in a status wherein the cursor 15 is positioned on the submenu 13 item of which the function is intended to be changed, the function of the selected submenu item is changed to either “ON” or “OFF”.

Accordingly, the user can change a setting state of the function in the photographing apparatus. However, in the conventional methods of displaying the menu, since the main menu 11 and the submenu 13 are not clearly discriminated, it is difficult for the user to recognize an association between the main menu 11 and the submenu 13. Furthermore, since the main menu 11 and the submenu 13 are respectively displayed on the left and right sides of the same screen 10, another problem can exist wherein the space for displaying the setting state of the submenu 13 (i.e., whether the corresponding submenu item is in a state of “ON” or “OFF”) is not sufficient. Therefore, since a size of each menu has to be smaller in order to secure the space, yet another problem can exist wherein it is inconvenient for the user to recognize the contents of the menu. In cases wherein there is a sub-submenu (not shown) that is provided in addition to the submenu 13, this problem is worsened.

Unlike FIG. 1A, FIG. 1B shows the menu 21 and 23 displayed altogether, without the divisions as provided for the main menu 11 and the submenu 13. The menu 21 is displayed on a left side of a screen 20, and a setting state 23 of each menu 21 is displayed on a right side of the screen 20. That is, as shown in FIG. 1B, a “COLOR/BW” menu item provided for determining whether the photographing apparatus is set to a color mode or a black and white mode is set to “COLOR” as the color mode. An “IRIS” menu item provided for setting an iris control state is set to “ALC” (Auto-iris Level Control). Further, a “SHUTTER” menu item is set to “AUTO×8”, a “MOTION” menu item is set to “F.FAST”, a “QUALITY” menu item is set to “1024×768” and a “TIMER” menu item is set to “OFF”.

In this example, if the user wants to change the setting state of a particular menu item, the user inputs a setting button after positioning a cursor 25 on the corresponding menu item. For example, if the cursor 25 is positioned on the “IRIS” menu item and the user inputs the setting button, the “ALC” mode is changed to an “ELC” (Electronic Level Control) mode. In this state, if the user presses the setting button once more, the “ELC” mode is returned to the “ALC” mode. In addition, if the user would like to set the photographing apparatus to the “BW” (Black and White) mode, the user positions the cursor 25 on the “COLOR/BW” menu item, and then presses the setting button so as to change the “COLOR” mode into the “BW” mode.

According to FIG. 1B, the problem of a lack of display space for the menu setting state or the sub-submenu is substantially reduced. However, the confusion in discriminating between the menu items is significantly increased. As a result, a problem exists wherein it is difficult for the user to easily recognize a relationship between the menu 21 and the menu setting state 23.

Another multi-purpose photographing apparatus having a function of the digital camera and the digital camcorder has also been recently developed and popularized. The multi-purpose photographing apparatus has more various kinds of menu items than each of the digital camera and the digital camcorder individually. Therefore, as shown in FIG. 1B, if each menu item is displayed one by one and the setting state thereof is then displayed, it is difficult for the user to grasp the entire function set of the multi-purpose photographing apparatus.

Accordingly, a need exists for a system and method of displaying an OSD menu which can improve the discrimination between the OSD menu items, and display the main menu and the submenu on the same screen.

### SUMMARY OF THE INVENTION

The present invention has been developed in order to solve the above drawbacks and other problems associated with the conventional arrangement. An aspect of the present invention is to provide a photographing apparatus for displaying an OSD menu and an implementation method thereof, in which a main menu is horizontally aligned and a discrimination between menu items is facilitated by using a difference in a size or a color of each menu item.

To achieve an aforementioned object of the present invention, a photographing apparatus is provided which can selectively take moving images and still images, comprising an OSD generating part for generating a plurality of OSD menu items in different colors respectively, a displaying part for displaying a list of the menu items on a screen, and a controlling part for controlling the OSD generating part and the displaying part so as to display a list of submenu items of a selected OSD menu item in the same color as the selected menu item when one of the OSD menu items is selected.

Preferably, the controlling part controls the OSD generating part and the displaying part so that the OSD menu items are horizontally aligned on an upper side of the screen, and the selected OSD menu item has a larger size than any other menu item.

The controlling part scrolls the menu list in a left and right direction by using an external selecting signal, and determines that the menu item is selected if a desired menu item is positioned on a particular place of the screen.

According to another embodiment of the present invention, a photographing apparatus is provided and comprises an OSD generating part for generating a plurality of OSD menu items in different colors respectively, a displaying part for displaying a list of the menu items on a screen, and a controlling part for controlling the OSD generating part and the displaying part so as to display a list of submenu items of a selected OSD menu item in the same color as the selected menu item when one of the OSD menu items is selected. Thus, the discrimination between menus can be improved.

Furthermore, a method of displaying an OSD menu according to the present invention is provided and comprises the steps of generating a plurality of OSD menu items in different colors respectively, aligning a list of the menu items horizontally on an upper side of a screen, and displaying a list of submenu items of a selected OSD menu item in the same color as the selected menu item.

Preferably, the method further comprises a step of enlarging a size of the selected OSD menu item and then displaying the enlarged menu item.

More preferably, the method further comprises steps of scrolling the menu list in a left and right direction by using an external selecting signal, and determining that the menu item is selected if a desired menu item is positioned on a particular place of the screen.

As described above, the method can be also applied to a general photographing apparatus such as a digital camcorder or a digital camera, as well as a multi-purpose photographing apparatus which can selectively take moving images and still images.

### BRIEF DESCRIPTION OF THE DRAWINGS

The above aspects and features of the present invention will become more apparent by describing certain embodiments of the present invention with reference to the accompanying drawings, in which:

FIGS. 1A and 1B are views showing a display state of an OSD menu in a conventional photographing apparatus;

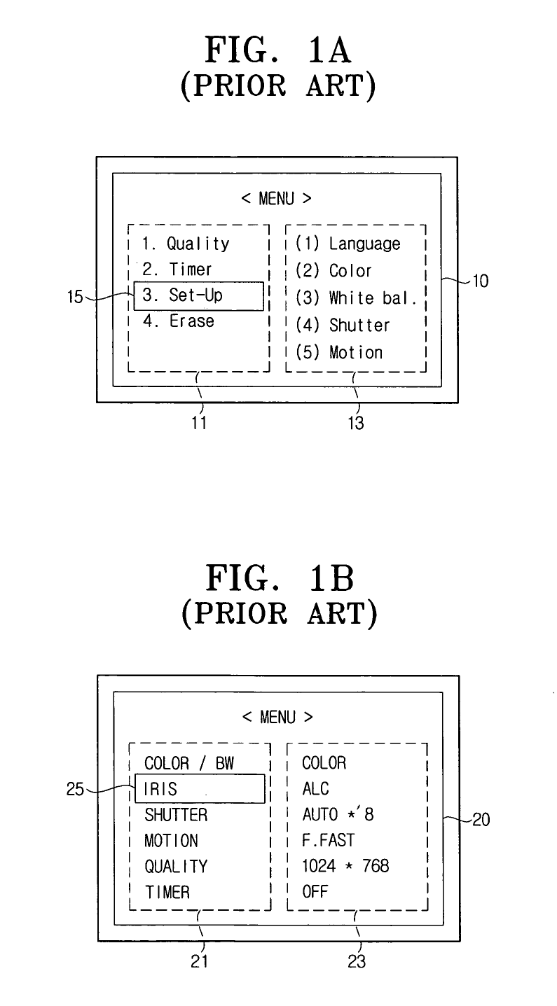

FIG. 2 is a block diagram showing a construction of a photographing apparatus according to an embodiment of the present invention;

FIGS. 3A and 3B are views showing a display state of an OSD menu in the photographing apparatus of FIG. 2 according to an embodiment of the present invention;

FIG. 4 is a block diagram showing a construction example of the photographing apparatus according to another embodiment of the present invention; and

FIG. 5 is a flow chart showing a method of displaying the OSD menu according to an embodiment of the present invention.

Throughout the drawings, like reference numerals will be understood to refer to like parts, components and structures.

### DETAILED DESCRIPTION OF EXEMPLARY EMBODIMENTS

Certain exemplary embodiments of the present invention will now be described in greater detail with reference to the accompanying drawings.

In the following descriptions, same drawing reference numerals are used for the same elements even in different drawings. The matters defined in the description such as detailed construction and element descriptions, are provided to assist in a comprehensive understanding of the invention. Also, well-known functions or constructions are not described in detail since they would obscure the invention in unnecessary detail.

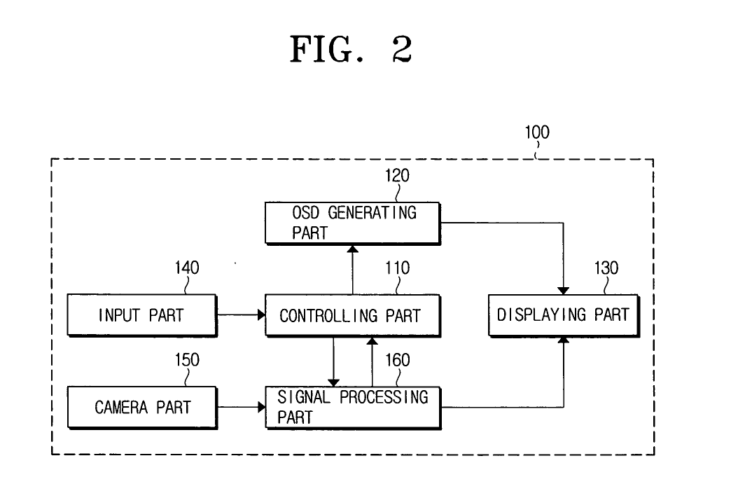

FIG. 2 is a block diagram showing a construction of a photographing apparatus according to an embodiment of the present invention. Referring to FIG. 2, a photographing apparatus 100 comprises a controlling part 110, an OSD generating part 120, a displaying part 130, an input part 140, a camera part 150, and a signal processing part 160.

If a user inputs a photographing signal using the input part 140, the controlling part 110 controls the camera part 150 so as to take an image of an object. Data of the taken image is processed in the signal processing part 160 and then recorded in a recording medium such as a memory card or a VCR tape (not shown). The controlling part 110 also displays the data on the displaying part 130 so that the user can visually confirm the image.

The displaying part 130 can display moving images or a still image of the object. If the user desires to change a setting state of the photographing apparatus 100 after confirming the moving images or still image, a menu provided in the photographing apparatus 100 is displayed on a screen by operating the input part 140.

That is, if a menu displaying order is input through the input part 140, the controlling part 110 controls the OSD generating part 120 so as to display an OSD type menu list to be set on the displaying part 130.

At this time, the OSD generating part 120 generates each to-be-displayed OSD menu item in different colors. The controlling part 110 controls the displaying part 130 to display the menu item selected from the menu list together with a submenu of the selected menu item. The menu list can be scrolled so that a position of each menu item is changed. Thus, the user can recognize that the menu item displayed in a particular position is selected. Alternatively, the user can move a cursor displayed on the menu list so as to select the menu item.

Once it is determined that a desired menu item is selected, the submenu of the selected menu item is also displayed on the screen by the controlling part 110. In this case, the submenu is displayed in the same color as the selected menu item. That is, a title of the submenu itself, or a background of an interface window in which the submenu is displayed, has the same color as the selected menu item. Therefore, it is possible to indirectly show that the submenu displayed on the screen is associated with the selected menu item.

The selected menu item may further have a larger size than any other menu items so that the user can easily recognize which menu item is selected.

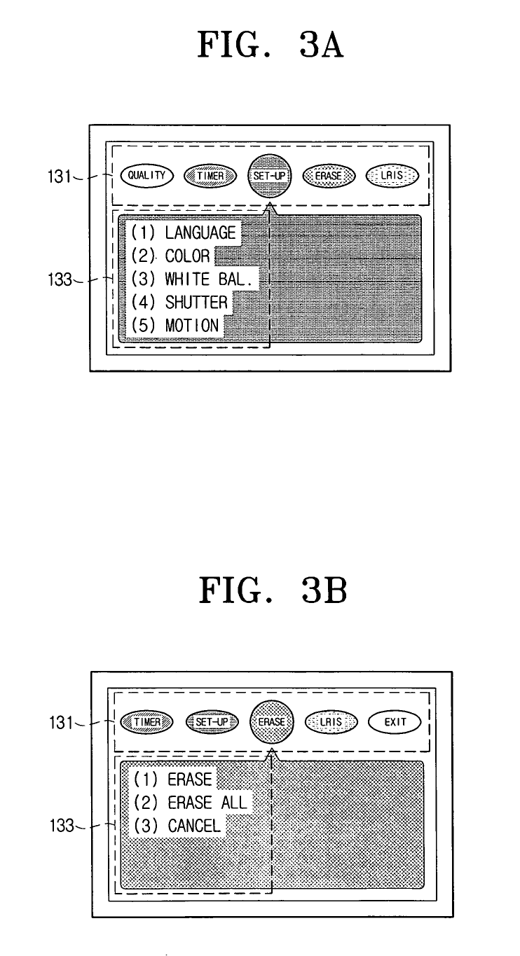

FIGS. 3A and 3B are views showing a display state of an OSD menu displayed on the displaying part 130 in the photographing apparatus according to an embodiment of the present invention.

Referring to FIG. 3A, a menu list 131 is horizontally aligned on an upper side of the screen. The displayed menu list 131 may be varied according to the type of photographing apparatus. That is, in a case of a digital camera, the menu items such as “Erase” and “Timer”, may be included in the main menu 131. In a case of a digital camcorder, the menu items such as “Hand-Shaking Correction”, “Auto Focus”, “Digital Effect” (e.g., Blurring Out, Make-Up Effect), may be included in the menu list 131. Each menu item included in the menu list 131 can be displayed in the form of a title or icon that shows a characteristic thereof.

According to FIG. 3A, the size of the menu item selected and positioned at a center part of the menu list 131 is enlarged, and a submenu list 133 of the menu item is displayed at a lower side of the menu list 131. Each menu item of the menu list 131 is displayed in different colors. Furthermore, a background of an interface window in which the submenu list 133 of the selected menu item is displayed is also displayed in the same color as the selected menu item, thereby allowing easy discrimination from other submenus of other menu items.

The user scrolls the menu list 131 in a left or right direction by using a left or right direction button (not shown) provided at the input part 140. Thus, the menu item selected and positioned at the center part of the menu list 131 can be changed.

FIG. 3B is a view showing a display status in a case wherein the right direction button is input while in the state wherein the “Set-Up” menu item is selected and positioned at the center part of the menu list 131. That is, FIG. 3B shows a movement from the selection “Set-Up” shown in FIG. 3A, to the adjacent menu list item “Erase”. Referring to FIG. 3B, the controlling part 110 controls the OSD generating part 120 so as to reduce the “Set-Up” menu item to the same size as other unselected menu items. The controlling part 110 then moves the “Set-Up” menu item to a left side and positions the “Erase” menu item at the center part of the screen. In this case, a scroll direction according to the input of the left and right direction button can be set in consideration of a user's convenience. That is, as shown in FIG. 3A, if the user would like to select a menu item on the right side of the screen, the user typically presses the right direction button. Thus, the menu list has to be moved to the left side.

At this time, the “Erase” menu item is enlarged to the same size as the previously selected “Set-Up” menu item. At a lower side of the “Erase” menu item, there is displayed the new submenu 133, including items such as “(1) Erase”, “(2) Erase All”, and “(3) Cancel”. In this case, the title or the background window of the submenu 133 is changed and now has the same color as the “Erase” menu item, so that the user can clearly recognize that the submenu is for the “Erase” menu item.

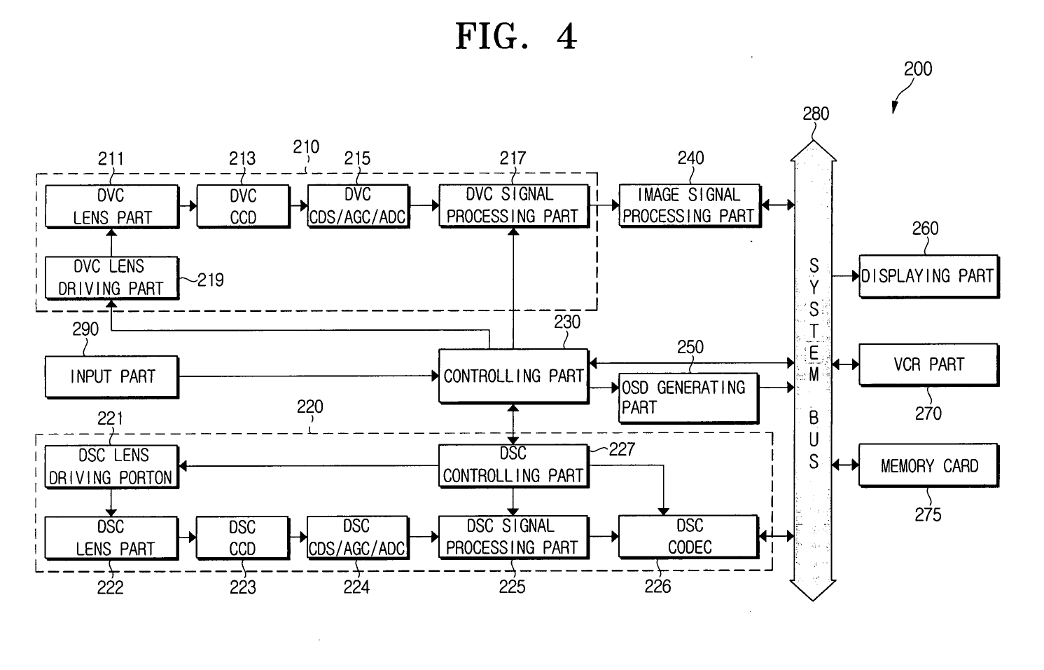

FIG. 4 is a block diagram showing a construction example of a multi-purpose photographing apparatus 200 having functions of both a digital camcorder and a digital camera according to another embodiment of the present invention. Referring to FIG. 4, the multi-purpose photographing apparatus comprises a DVC (Digital Video Camera) module 210, a DSC (Digital Still Camera) module 220, a controlling part 230, an image signal processing part 240, an OSD generating part 250, a VCR (Video Cassette Recorder) unit 270, a memory card 275, a system bus 280, and an input part 290.

The DVC module 210 converts an optical signal, which is input through a lens, into an electric signal and then performs a desired signal process for the converted signal. All of the moving images and the still images can be taken by the DVC module 210. However, the still images taken by the DVC module 210 can have a lower image quality than those taken by the DSC module 220. Therefore, the DVC module 210 is generally used in taking the moving images only. The DVC module 210 is provided with a DVC lens part 211, a DVC lens driving part 219, a DVC CCD (Charge Coupled Device) part 213, a DVC CDS/AGC/ADC (Correlated Double Sampler/Auto Gain Controller/Analog-to-Digital Converter) part 215 and a DVC signal processing part 217.

The controlling part 230 directs the DVC lens driving part 219 to control a zoom-in/zoom-out operation of the DVC lens part 211, automatically control a focus, and also control an opening and closing degree of an iris (not shown) provided in the lens part 211.

The DVC CCD part 213 then converts an optical image, which is input through the DVC lens part 211, into an electric signal, and then outputs the converted signal to the DVC CDS/AGC/ADC part 215.

The DVC CDS/AGC/ADC part 215 eliminates noise from the electric signal output from the DVC CCD part 213 by using the CDS, and controls a gain by using the AGC so that a level of the signal is kept constant. The DVC CDS/AGC/ADC part 215 then converts the signal into a digital signal by using the ADC.

The DVC signal processing part 217 divides the digital signal output from the DVC CDS/AGC/ADC part 215 into a luminance signal and a chrominance signal, and then performs operations of gain control, contour correction, and AWB (Auto White Balance).

The DSC module 220 converts an optical signal, which is input through a lens, into an electric signal and then performs a desired signal process for the converted signal. All of the moving images and the still images can also be taken by the DSC module 220. However, a data capacity of the moving images taken by the DSC module 220 is much larger than that taken by the DVC module 210. As a result, since a large memory space is required when recording the moving images data in a recording medium, it is substantially impossible to take the moving images for a long period of time. Therefore, the DSC module 220 is generally used in taking the still images.

The DSC module 220 is provided with a DSC lens part 222, a DSC lens driving part 221, a DSC CCD part 223, a DSC CDS/AGC/ADC part 224, a DSC signal processing part 225, a DSC CODEC (Encoder/Decoder) part 226 and a DSC controlling part 227.

The DSC controlling part 227 communicates with the controlling part 230 and controls the operations of the DSC lens driving part 221, the DSC signal processing part 225, and the DSC CODEC part 226.

The DSC lens driving part 221 drives the DSC lens part 222 according to the control of the DSC controlling part 227. Specifically, the DSC lens driving part 221 controls a zoom-in/zoom-out operation of the DSC lens part 222, automatically controls a focus, and also controls an opening and closing degree of an iris (not shown) provided in the DSC lens part 222.

The DSC CCD part 223 converts an optical image, which is input through the DSC lens part 222, into an electric signal. Further, the DSC CDS/AGC/ADC part 224 eliminates noise from the electric signal output from the DSC CCD part 223, and controls a gain so that a level of the signal is kept constant. The DSC CDS/AGC/ADC part 224 then converts the signal into a digital signal. The DSC signal processing part 225 divides the digital signal output from the DSC CDS/AGC/ADC part 224 into a luminance signal and a chrominance signal, and then performs operations of gain control, contour correction, and AWB (Auto White Balance).

The DSC CODEC part 226 compresses the signal output from the DSC signal processing part 225 in a predetermined format, and then supplies the compressed signal to the image signal processing part 240 using the system bus 280. In the example shown in FIG. 4, a JPEG format can be applied as the compressing type, however any suitable format may be applied.

The image signal processing part 240 functions to record the taken image in the recording medium, or to reproduce the image recorded in the recording medium.

That is, in cases wherein the multi-purpose photographing apparatus 200 is operated in a DVC photographing mode, the image signal processing part 240 can compress the image signal in a DV format or MPEG format. Further, the image signal processing part 240 can convert an audio signal output from a microphone (not shown) into a digital signal, and compress the converted signal in a PCM format or G.726 format. The compressed signal is then recorded in the VCR unit 270 or the memory card 275 as directed by the controlling part 230. The VCR unit 270 records the image signal on a VCR tape mounted in a VCR deck (not shown).

In cases wherein the multi-purpose photographing apparatus 200 is operated in a DSC photographing mode, the image signal processing part 240 displays the image signal, which is taken by the DSC module 220 and then processed in the DSC signal processing part 225, through the displaying part 260 on the screen. In addition, the image signal processing part 240 records the compressed signal supplied from the DSC CODEC part 226 in the memory card 275 according to the control of the controlling part 230.

In a reproducing mode, the image signal processing part 240 extracts the compressed image signal recorded in the VCR unit 270 or the memory card 275, and then supplies the extracted image signal to the displaying part 260 so as to reproduce the moving images or still images on the screen.

If the user inputs an operating signal for setting the menu through the input part 290, the controlling part 230 controls the OSD generating part 250 and the displaying part 260 so that the OSD menu is displayed on the screen. In this case, since the multi-purpose photographing apparatus 200 has the functions of both the digital camcorder and the digital camera, and is operated in various modes such as the DVC photographing mode, DSC photographing mode, DVC reproducing mode and DSC reproducing mode, the number of menu items is considerably increased.

Thus, the controlling part 230 can be adapted to control the display of only the menu items that can be set in the present mode. If the apparatus 200 is in a status wherein a kind of menu to be displayed is standardized in any mode, the controlling part 230 can be further adapted to activate only the menu items that can be selected in the present mode and inactivate other menu items. A manufacturer can determine and configure this operation of the controlling part 230 in consideration of user's convenience.

The controlling part 230 aligns the multiple menu items in one direction on the screen so that the user can easily recognize the displayed menu items. In this case, the menu items may be vertically aligned on the left side of the screen. However, in order to display the submenu as well as the menu setting state on the comparative small LCD screen, it is preferred that the menu items are horizontally aligned on the upper side of the screen.

The user can scroll the aligned menu items by operating the one or more direction buttons provided in the input part 290. The controlling part 230 regards the menu item positioned at a particular place, for example, the center position of the horizontal alignment of menu items as shown in 131 of FIGS. 3A and 3B at the center part of the upper side of the screen, as the selected menu item. Therefore, the controlling part 230 controls the OSD generating part 250 and the displaying part 260 so that the selected OSD menu item has a larger size relative to other menu items and, at the same time, the submenu of the selected menu item is aligned on a lower side of the screen.

At this time, the OSD generating part 250 can further generate OSD menu items having a different color from each other respectively. The submenu of each menu item is provided to also have the same color as the corresponding menu item. Thus, the user can easily recognize the association between each menu item and its submenu.

In use, the user can position the cursor on a desired submenu item by operating the one or more up and down direction buttons provided in the input part 290, and can then press the selecting button so as to set a desired function.

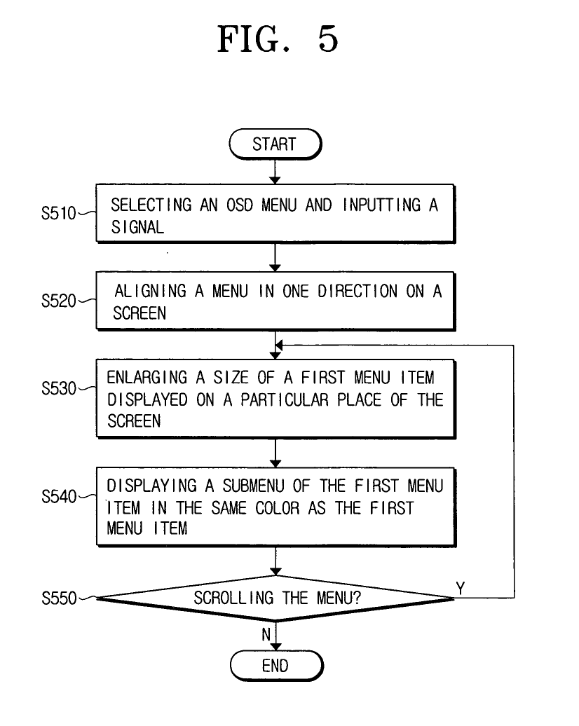

FIG. 5 is a flow chart showing an exemplary method of displaying the OSD menu in the multi-purpose photographing apparatus shown in FIG. 4 in accordance with an embodiment of the present invention. First, if the user inputs an operating signal through the input part 230 at step (S510), the controlling part 230 controls the OSD generating part and the displaying part 260 so as to display the multiple OSD menu items on the screen at step (S520). In this case, it is preferred that the OSD menu items are horizontally aligned on the upper side of the screen. Further, each menu item can be displayed in the form of an icon for showing a characteristic of each menu item, as well as a title of the menu item.

The controlling part 230 regards a menu item displayed at a particular place, for example, the center position of the horizontal alignment of menu items as shown in 131 of FIGS. 3A and 3B at the center part of the upper side of the screen, as the first or selected menu item, and then enlarges a size of the selected menu item at step (S530).

In this case, each OSD menu item is provided by the controlling part 230 as having a different color, and a submenu of the selected first OSD menu item is also provided having the same color as the first OSD menu item at step (S540). Thus, the discrimination between the menu items can be increased.

If the user scrolls the menu items aligned on the upper side of the screen by using the left or right direction buttons at step (S550), the first menu item can be changed. Since the first menu item is changed to another menu item, a size of the newly selected menu item is enlarged, and a submenu of the newly selected menu item is displayed by returning to step (S530).

Accordingly, the user can confirm the selectable menu items by a simple operation, and can also easily recognize the main menu item on which the submenu is dependent.

According to the present invention as described above, since the menu for setting a function of the photographing apparatus is horizontally aligned on the upper side of the screen, the user can easily select the desired menu item by using the direction button. Further, since each OSD menu item has a different color, and the submenu of the selected menu item has the same color as the selected menu item, discrimination between the menu items and between the menus is more easily determined. Furthermore, since the selected OSD menu item has a larger size than other menu items, the user can easily recognize the selected menu item.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A multi-purpose photographing apparatus which can selectively take moving images and still images, comprising:
an on screen display (OSD) generating part for generating a plurality of OSD menu items in different colors, respectively;
a displaying part for displaying a list of the menu items on a screen; and
a controlling part for controlling the OSD generating part and the displaying part so as to display a list of submenu items of a selected OSD menu item in the same color as the selected OSD menu item when one of the OSD menu items is selected.

2. The apparatus according to claim 1, wherein the controlling part is configured to control the OSD generating part and the displaying part so that the OSD menu items are provided as icons that are horizontally aligned on an upper side of the screen.

3. The apparatus according to claim 2, wherein the controlling part is further configured to control the OSD generating part and the displaying part so that the selected OSD menu item icon has a larger size than any other menu item icon.

4. The apparatus according to claim 2, wherein the controlling part is further configured to scroll the OSD menu items in a left or right direction in response to an external selecting signal, and to determine that an OSD menu item is selected if the OSD menu item is positioned on a particular place of the screen.

5. A photographing apparatus, comprising:
an on screen display (OSD) generating part for generating a plurality of OSD menu items in different colors, respectively;
a displaying part for displaying a list of the menu items on a screen; and
a controlling part for controlling the OSD generating part and the displaying part so as to display a list of submenu items of a selected OSD menu item in the same color as the selected menu item when one of the OSD menu items is selected.

6. The apparatus according to claim 5, wherein the controlling part is configured to control the displaying part so that the OSD menu items are provided as icons that are horizontally aligned on an upper side of the screen.

7. The apparatus according to claim 6, wherein the controlling part is further configured to scroll the OSD menu items in a left or right direction in response to an external selecting signal.

8. The apparatus according to claim 6, wherein the controlling part is further configured to control the OSD generating part and the displaying part so as to enlarge a size of the selected OSD menu item icon and then display the enlarged menu item icon.

9. A method of displaying an on screen display (OSD) menu in a multi-purpose photographing apparatus which can selectively take moving images and still images, comprising steps of:
generating a plurality of OSD menu items in different colors, respectively;
aligning a list of the OSD menu items horizontally on an upper side of a screen; and
displaying a list of submenu items of a selected OSD menu item in the same color as the selected OSD menu item.

10. The method according to claim 9, further comprising the step of enlarging a size of the selected OSD menu item and then displaying the enlarged OSD menu item.

11. The method according to claim 9, further comprising the steps of:
scrolling the OSD menu list in a left or right direction in response to an external selecting signal; and
determining that an OSD menu item is selected if the OSD menu item is positioned on a particular place of the screen.
